(19) United States
(12) Patent Application Publication
(10) Pub. No.: US 2026/0227511 A1
(43) Pub. Date: Aug. 6, 2026

(54) OPTICAL SENSOR FOR MEASURING THE PROPAGATION TIME OF ELECTROMAGNETIC BEAMS WITH LOW INTERFERENCE

(71) Applicant: DORMAKABA EAD GMBH, Villingen-Schwennigen (DE)

(72) Inventor: Martin RUOF, Villingen-Schwennigen (DE)

(21) Appl. No.: 19/148,188

(22) PCT Filed: Oct. 26, 2023
(86) PCT No.: PCT/EP2023/079961

§ 371 Date: Jul. 15, 2025

(30) Foreign Application Priority Data
Jan. 18, 2023 (EP) 23152274.9

(51) Int. Cl. G01S 17/08; G01S 7/481; G06V 10/147; G06V 40/16

(52) U.S. Cl. CPC G01S 17/08; G01S 7/4813; G06V 10/147; G06V 40/166

(57) ABSTRACT

An optical sensor with a prism positioned between a detector of the sensor and a cover. A surface normal of a first prism flank of the prism directed outwardly starting from the prism points in the direction of the detector. A surface normal of a second prism flank of the prism directed outwardly starting from the prism points in the direction of the cover. Limbs of a prism angle extend along the first and second prism flank. A first sensor axis runs in a direction through the detector and the cover. A second sensor axis is orthogonal to the first sensor axis. The first prism flank is oriented obliquely towards the second sensor axis at a tilt angle. The tilt and prism angles have angular sizes whereby interference beams propagate partially past the detector, with the interference beams generated by reflection of beams emitted from the transmitter, on the cover.

### CROSS-REFERENCE TO RELATED APPLICATIONS

This application is a 35 U.S.C. § 371 National Stage patent application of PCT/EP2023/079961 filed 26 Oct. 2023, which claims the benefit of European patent application 23152274.9 filed 18 Jan. 2023, the disclosures of which are incorporated herein by reference in their entirety.

### TECHNICAL FIELD

The disclosure relates to an optical sensor for low-interference travel time measurement of reflected electromagnetic beams. The disclosure also relates to a sensor system with such a sensor. The disclosure further relates to an electronic interaction device with such a sensor system. In addition, the disclosure relates to a use of optical elements for operating such a sensor and a method for mounting such a sensor.

### BACKGROUND

Optical sensors for measuring the distance of objects by way of travel time measurements are known from the prior art, in which transmitters emit electromagnetic beams that are reflected on the objects and detected by detectors of the sensors. Some of the emitted beams are typically reflected on the cover windows of the sensors and radiate into the detectors without leaving the sensors. This falsifies or completely prevents travel time measurements of the beams reflected on the objects. In order to reduce such crosstalk of the detector in question, it is also known from the prior art to arrange a shielding element between the detector and the cover, which shielding element blocks the beams reflected by the cover.

However, the shielding element can only shield the detector from a part of the radiation reflected on the cover. Furthermore, a shielding element restricts the emission angle of the beams emitted from the transmitter due to the absorbing effect.

### SUMMARY

The disclosure provides an improved optical sensor for the travel time measurement of electromagnetic beams. The disclosure provides a sensor system and an electronic interaction device with such a sensor. Furthermore, the disclosure provides a method for using optical elements to operate such a sensor and a method for mounting such a sensor.

According to the disclosure, this is achieved by providing an optical sensor according to the claims. A sensor system according to the disclosure has the features according to the claims. An electronic interaction device according to the disclosure is designed with the features according to claim 19. A method according to the disclosure for using optical elements to operate the sensor has the steps indicated in the claims. A method according to the disclosure for mounting the sensor is carried out according to the steps mentioned in the claim. Advantageous configurations can be found in the related dependent claims.

The optical sensor for low-interference travel time measurement of reflected electromagnetic beams has the following elements:
a transmitter for transmitting the electromagnetic beams through a cover, with the cover being permeable to at least a part of the beams emitted by the transmitter;
a detector for detecting the electromagnetic beams;
a first sensor axis that runs in a direction from the detector to the cover, with the first sensor axis being orthogonal to the cover;
a second sensor axis that is orthogonal to the first sensor axis;
   with a prism being arranged between the detector and the cover, with the prism having a first prism flank facing the detector, with the first prism flank being inclined at a tilt angle in relation to the second sensor axis,
   with the prism having a second prism flank which adjoins the first prism flank and which faces the cover, with a prism angle being formed between the first prism flank and the second prism flank,
   with a third prism flank adjoining the first prism flank and the second prism flank, with the prism angle and the tilt angle being designed in such manner that interference beams are at least partially deflected past the detector by means of the prism, with the interference beams being generated by electromagnetic beams being emitted by the transmitter in the direction of the cover and being reflected on the prism and/or the cover.

The sensor is used to detect objects using electromagnetic beams that are emitted by the transmitter and reflected back to the detector on objects outside the sensor. Such beams are also referred to as useful beams in the context of the application. Electromagnetic beams incident on the cover are in particular split into useful beams and interference beams. A portion of the electromagnetic beams incident on the cover that is transmitted through the cover forms the useful beams, whereas a portion reflected by the cover represents interference beams. The interference beams are, in particular, electromagnetic beams that are generated from the beams emitted by the transmitter by reflection on the cover and/or the prism and are directed towards the detector after this reflection. Interference beams are in particular electromagnetic beams that impair the functionality of the detector. The useful beams are in particular electromagnetic beams that are generated from beams emitted by the transmitter by transmission through the cover and are directed outwards as seen from the sensor. Such a portion of interference beams is in particular deflected past the detector such that a noise signal or interference signal in the detector remains below a desired threshold value. A portion of 50%, 60%, 70%, 80%, 90% or 95% of the interference beams is preferably deflected past the detector.

The prism advantageously prevents the useful beams from being superimposed by interference beams that propagate starting from the cover in the direction of the detector. This is achieved in particular by total reflection of the interference beams on the first prism flank after they have been reflected by the cover. This reduces or completely prevents crosstalk between the signals to be detected. In other words, noise or interference from signals generated by the useful beams is greatly reduced. The prism is arranged in particular on a side of the cover that faces the detector and/or the transmitter. A side of the cover facing the detector and/or the transmitter is understood in particular to be a side of the cover with a surface normal which is directed outwards as seen from the cover and which is directed in the direction of the detector and/or the transmitter. The prism preferably has adhesive surfaces and/or adhesive pads for adhering to the cover.

A surface normal of the first prism flank directed outwardly as seen from the prism preferably points towards the detector and/or the transmitter. A surface normal of the second prism flank directed outwardly as seen from the prism preferably points towards the cover. The first prism flank preferably has a smaller distance to the detector than the second prism flank. The second prism flank preferably has a smaller distance to the cover than the first prism flank.

The sensor in particular has the purpose of recognising a person approaching the sensor and/or recognising a finger of a person approaching the sensor in order to activate a fingerprint sensor (from a sleep mode) which identifies the person in question on the basis of a pattern of the fingerprint of the finger. The sensor can have adhesive pads and/or holding surfaces for adhesive pads for attaching the sensor to holding elements. The sensor preferably has an array of 8×8 pixels.

The first sensor axis points in particular in the horizontal direction, the second sensor axis preferably in the vertical direction. The detector is preferably soldered to a vertically oriented circuit board.

In an advantageous configuration of the sensor, the prism is arranged in the direction of the first sensor axis between the detector, the transmitter and the cover, with the first prism flank also facing the transmitter. This prevents beams emitted by the transmitter from being reflected back into the transmitter.

In a preferred embodiment of the sensor, the third prism flank has a predetermined roughness in order to reduce reflections of electromagnetic radiation on the third prism flank. The third prism flank is preferably oriented in such manner that a centre line runs through the third prism flank parallel to the first sensor axis. By roughening the third prism flank, reflections of electromagnetic radiation on the third prism flank within the prism can be greatly reduced in order to prevent interference signals due to multiple reflected electromagnetic beams. The centre line results in particular as a compensation line of measured values for determining the roughness profile of the third prism flank in a predefined direction.

In an advantageous variant of the sensor, the transmitter is configured to emit electromagnetic beams in a first beam plane, which is defined by the first sensor axis and the second sensor axis, with a first divergence angle DW1 with 40°≤DW1≤50°, preferably DW1=45°, with the first sensor axis running through the apex of the first divergence angle and between the limbs of the first divergence angle, with the first sensor axis in particular forming an angle bisector of the first divergence angle. At this first divergence angle, the electromagnetic radiation emitted by the sensor has in the first beam plane a comparatively large detection range with a comparatively uniform radiation density in order to reliably detect objects in the outer region of the sensor.

The detector is preferably configured to receive electromagnetic beams in the first beam plane at a receiving angle EW with 40°≤EW≤50°, preferably EW=45°, with the first sensor axis running through the apex of the receiving angle and between the limbs of the receiving angle, with the first sensor axis in particular forming an angle bisector of the receiving angle.

In a further development of the aforementioned variant, the transmitter is configured to emit electromagnetic radiation in a second beam plane, which is orthogonal to the first beam plane, at a second divergence angle DW2 with 40°≤DW2≤50°, preferably DW2=45°, with the first sensor axis running through the second beam plane. This allows a comparatively large solid angle outside the sensor to be illuminated by the beams from the transmitter, with the radiation density of the electromagnetic radiation having a comparatively high homogeneity. The divergence angles DW1 and DW2 in particular together determine the field of view of the optical sensor.

In an advantageous configuration of the sensor, the prism is configured to refract the beams emitted by the transmitter in an irradiation direction which has a first directional component parallel to the second sensor axis, with the first directional component being directed from a prism edge, which is opposite the third prism flank, to the third prism flank, with a second directional component of the irradiation direction being directed parallel to the first sensor axis. The beams are deflected in the direction of the first directional component as they emerge from the sensor in order to simultaneously detect various objects, in particular reflectors, which are offset in relation to one another along the second sensor axis. This applies in particular to the case where one or a plurality of reflectors are located along the second sensor axis below the prism and/or the cover. The reflectors are, for example, a person and a finger approaching the sensor or an identification card to identify a person.

In preferred configurations of the sensor, the prism is configured to refract the beams emitted by the transmitter in such manner that, after emerging from the cover in the first beam plane, useful beams branched off from the emitted beams have a third divergence angle DW3, the angular size of which corresponds to the angular size of the first divergence angle DW1. On the one hand, this prevents the beams from being bundled, which could lead to damage to objects outside the sensor. On the other hand, at such a divergence angle DW3, the transmission power or radiant power of the electromagnetic radiation outside the sensor is not reduced or only reduced comparatively slightly by the influence of the prism. Therefore, the range at which the sensor can detect objects, in particular people, is not reduced by the prism.

In an advantageous variant of the sensor, the following applies for the tilt angle κs: 30°≤κs≤40°, in particular κs=37°, and/or for the prism angle α: 40°≤α≤50°, in particular α=45°. With these angular sizes, crosstalk between the signals to be detected is greatly reduced, in particular if the electromagnetic beams are emitted by the transmitter with the aforementioned angular sizes of the first and second divergence angles. With a tilt angle κs=37° and a prism angle α=45°, the solid angle into which the useful beams radiate is shifted comparatively little by the prism. As a result, approaching persons, in particular the bodies of such persons, preferably their faces (e.g. with vertical alignment of the second sensor axis), can be recognised comparatively easily by the sensor. In this variant of the sensor, the second prism flank is inclined towards the cover in such manner that the distance between the cover and the second prism flank decreases in the direction from the aforementioned prism edge to the third prism flank. The resulting total reflections of interference beams, which are reflected on the cover, on the second prism flank significantly prevent the interference beams from radiating into the detector.

In further developments of the aforementioned variant of the sensor, the size of the tilt angle κs and the size of the prism angle α is given by one of the following pairs of values (α, κS):

$$( α = 43 ° , κ s = 34.9 ° \pm 0.6 ° ) ,$$

$$( α = 44 ° , κ s = 35.8 ° \pm 0.6 ° ) ,$$

$$( α = 45 ° , κ s = 36.7 ° \pm 0.5 ° ) ,$$

$$( α = 46 ° , κ s = 37.6 ° \pm 0.5 ° ) or$$

$$( α = 47 ° , κ s = 38.5 ° \pm 0.5 ° ) ,$$

in particular

$$( α = 43 ° , κ s = 34.9 ° ) , ( α = 43 ° , κ s = 35 ° ) ,$$

$$( α = 44 ° , κ s = 35.8 ° ) , ( α = 44 ° , κ s = 36 ° ) ,$$

$$( α = 45 ° , κ s = 36.7 ° ) , ( α = 45 ° , κ s = 37 ° ) ,$$

$$( α = 46 ° , κ s = 37.6 ° ) , ( α = 46 ° , κ s = 38 ° ) ,$$

$$( α = 47 ° , κ s = 38.5 ° ) , ( α = 47 ° , κ s = 39 ° ) ,$$

$$( α = 48 ° , κ s = 39.5 ° ) or ( α = 48 ° , κ s = 40 ° ) .$$

Crosstalk between the signals to be detected is prevented with these angular sizes. The divergence angles of the beams emerging from the sensor do not change or change only slightly compared to the divergence angles of the beams emitted by the transmitter such that the field of view of the sensor is neither fanned out nor reduced.

In advantageous configurations of the sensor, the transmitter and the detector are arranged next to one another in a direction parallel to a third sensor axis, with the third sensor axis running orthogonally to the first sensor axis and the second sensor axis, with in particular the transmitter being aligned to emit electromagnetic beams with a beam direction that has a directional component perpendicular to the third sensor axis and the detector being aligned to detect electromagnetic beams with a beam direction that has a directional component perpendicular to the third sensor axis. This results in a simple arrangement of the components of the sensor in order to avoid crosstalk from the detector.

In advantageous configurations of the sensor, the prism has PMMA and/or a polycarbonate, with the prism consisting in particular of PMMA and/or a polycarbonate. PMMA is characterised by a comparatively high degree of transmission. Polycarbonates have high dimensional stability with a good degree of transmission.

In a preferred variant, the sensor, in particular the prism, has at least one optical surface and at least one adhesive surface, with the optical surface being such a surface that is designed to transmit electromagnetic beams from the transmitter. The adhesive surfaces advantageously allow the sensor to be fastened to external objects in a simple and stable manner by adhesion. The adhesive surfaces are preferably designed to be fastened to the cover.

In a further development of the aforementioned variant, the optical surface adjoins at least one, preferably at least two, adhesive surface(s), with the optical surface and the adhesive surface(s) preferably being arranged next to one another in a direction perpendicular to the first sensor axis. This enables particularly stable fastening of the optical surface by way of the adhesive surfaces on both sides.

The adhesive surface(s) preferably run(s) at an acute angle to the optical surface such that the adhesive surface(s) is/are raised with respect to the optical surface. The plane in which the optical surface runs and the plane in which the adhesive surface(s) run(s) in particular include the acute angle. By selecting a suitable angle between the optical surface and the adhesive surfaces, it is easy to ensure that when the sensor is adhered to an external object, the optical surface already has a suitable alignment to a desired orientation of the electromagnetic beams which hit the optical surface.

In an advantageous configuration of the sensor, the optical surface is formed as the first prism flank or the second prism flank. By way of at least one adhesive surface, which runs at a suitable angle to the first prism flank and/or the second prism flank, it can be advantageously ensured in a simple manner that when the sensor is adhered to the adhesive surface, the first prism flank is already aligned at the tilt angle to the second sensor axis. In this case, the adhesive surface is preferably oriented parallel to the second sensor axis due to its alignment relative to the respective prism flank.

A sensor system according to the disclosure has an aforementioned sensor and a cover, with in particular a side surface of the cover, which is configured to be irradiated by the electromagnetic beams emitted by the transmitter, extending parallel to the second sensor axis. In such a sensor system, the detector of the sensor is particularly well protected against crosstalk caused by beams reflected on the cover.

In preferred embodiments of the sensor system, the cover comprises glass, PMMA and/or a polycarbonate, with the cover consisting in particular of glass, PMMA and/or a polycarbonate. The glass may have organic glass components, in particular plastics such as acrylic glass. In some embodiments of the sensor system, a filter layer is arranged on the cover, preferably on the side of the cover facing the transmitter and/or the detector. The filter layer is preferably printed on the cover. The filter layer is in particular partially or completely impermeable to electromagnetic waves in the visible range of the electromagnetic spectrum. The filter layer is designed to be permeable to electromagnetic waves emitted by the transmitter, in particular electromagnetic waves with frequencies in the infra-red range.

In a preferred configuration of the sensor system, the sensor is fastened to the cover by way of an adhesive connection. This means the sensor system has a simple structure which is advantageous for stable positioning and alignment of the sensor.

In an advantageous embodiment, the sensor system has a further sensor, in particular a biometric sensor, preferably a fingerprint sensor and/or a facial recognition camera. This enables different signals to be detected by the sensor and the further sensor in order to clearly identify an object or a person. The further sensor is in particular designed to be activated when the sensor system detects a process that indicates a possible imminent interaction with the sensor system, for example the approach of a person to the interaction system.

An electronic interaction device according to the disclosure for inputting and/or outputting signals has an aforementioned sensor system, with the electronic interaction device being designed in particular as a car entertainment system, an access control device, a time recording terminal and/or an attendance recording system.

When a prism is used to operate an aforementioned sensor, interference beams are at least partially deflected past the detector by means of the prism, with the interference beams being generated by electromagnetic beams being emitted from the transmitter in the direction of the cover and reflected on the prism and/or the cover. By using the prism, the detector is particularly well protected from interference beams.

A method for mounting an aforementioned sensor also falls within the scope of the disclosure.

In a preferred configuration of the mounting method, the sensor is fastened to a holding element by way of a joining process.

In an advantageous variant, the sensor is fastened to the cover by adhesion. By adhering the sensor to the cover, the prism, the detector and the transmitter can be aligned with high accuracy and stability. In the case of adhesion, adhesive guides can be used, which are formed by a form-fit, for example.

As part of a preferred configuration of the mounting method according to the disclosure, there is also a configuration in which at least one marking is used to position the sensor, with the marking in particular being able to be removed non-destructively, preferably by wiping. The marking simplifies the correct positioning of the sensor in the mounting process.

In an advantageous variant of the mounting method, at least one carrier is used to position the sensor. The carrier additionally stabilises the sensor during mounting.

In a further configuration of the mounting method, at least one template is used to position the sensor. Advantageously, the template can be reused for mounting a plurality of sensors in order to achieve precise positioning of the respective sensors.

In a preferred variant of the method, a housing is used as a guide to position the sensor. The housing or part of the housing provides particularly stable guidance of the sensor for its precise positioning.

Further advantages of the disclosure are found in the description and the drawing. Likewise, the above-mentioned features and those described in more detail below can be used individually or in any combination according to the disclosure. The embodiments shown and described are not to be understood as an exhaustive list, but rather have an exemplary character for the description of the disclosure.

### BRIEF DESCRIPTION OF THE DRAWINGS

FIG. 1 schematically shows a top view of a sensor system with an optical sensor for low-interference travel time measurement of electromagnetic beams;

FIG. 2 schematically shows a sectional view of the sensor system;

FIG. 3 shows an isometric view of a prism of the sensor;

FIG. 4 shows a schematic side view of the sensor system, with the prism being fastened to a cover.

### DETAILED DESCRIPTION OF THE DRAWINGS

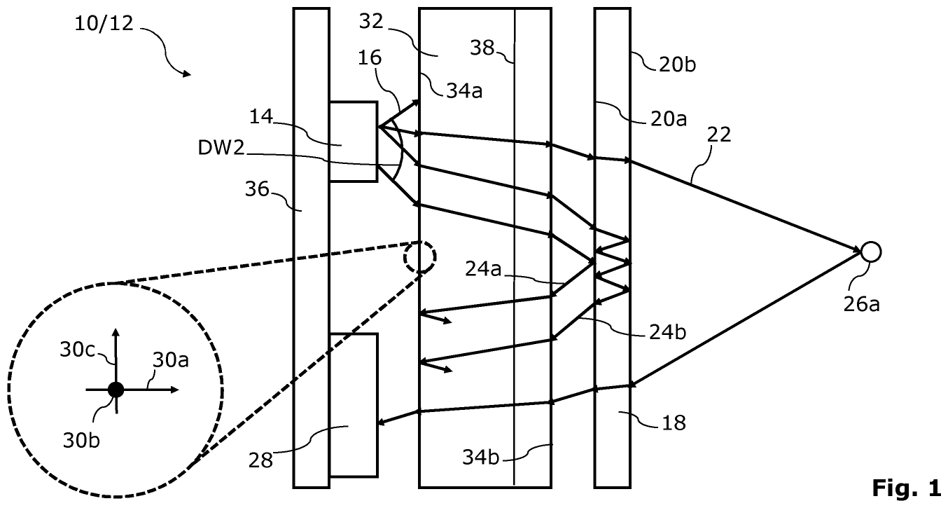

FIG. 1 schematically shows a sensor system 10 with an optical sensor 12 for low-interference travel time measurement of electromagnetic radiation. In order to emit the electromagnetic radiation, the optical sensor 12 has a transmitter 14. The beams 16 emitted from the transmitter 14 propagate at least partially to a cover 18, which serves to protect the optical sensor 12. At the cover 18, the emitted beams 16 are split into beams that are transmitted through the cover 18 and beams that are reflected by side surfaces 20a, 20b of the cover 18.

The beams which are transmitted through the cover 18 and which are directed outwardly as seen from the sensor 12, are referred to in particular as useful beams in the context of the application. FIG. 1 shows a useful beam 22 by way of example. The beams which are reflected by the cover 18 and which are directed into the interior of the sensor 12, are referred to in particular as interference beams in the context of the application. FIG. 1 shows interference beams 24a, 24b by way of example.

The useful beams 22 are reflected on a first reflector 26a and reflected back through the cover 18 into the sensor 12. The first reflector 26a is in particular a person approaching the sensor 12, in particular at least parts of the body of such a person, preferably the face of such a person, with the approach of the person being intended to be recognised by the sensor 12. After reflection, the useful beams 22 are detected in a detector 28 of the sensor 12. The distance between the sensor 12 and the first reflector 26a can be determined from the travel time of the useful beams 22 on their path between the sensor 12 and the first reflector 26a. The transmitter 14 and the detector 28 are mounted on a bracket 36. The bracket 36 belongs in particular to a housing (not shown) of the sensor 12, with the housing preferably being soldered to a circuit board.

The interference beams 24a, 24b are reflected on the side surfaces 20a, 20b of the cover 18 and radiate back in the direction of the detector 28. As a result, the interference beams 24a, 24b have a short travel time and typically generate a noise signal or an interference signal in the detector 28, which degrades the accuracy of the travel time measurement of the beams 22 reflected on the first reflector 26a or completely prevents the travel time measurement. The phenomenon of superposition of the useful beams 22 with the interference beams 24a, 24b in the detector 28 is also referred to as crosstalk of the detector 28. According to the disclosure, such crosstalk should be prevented or at least significantly reduced.

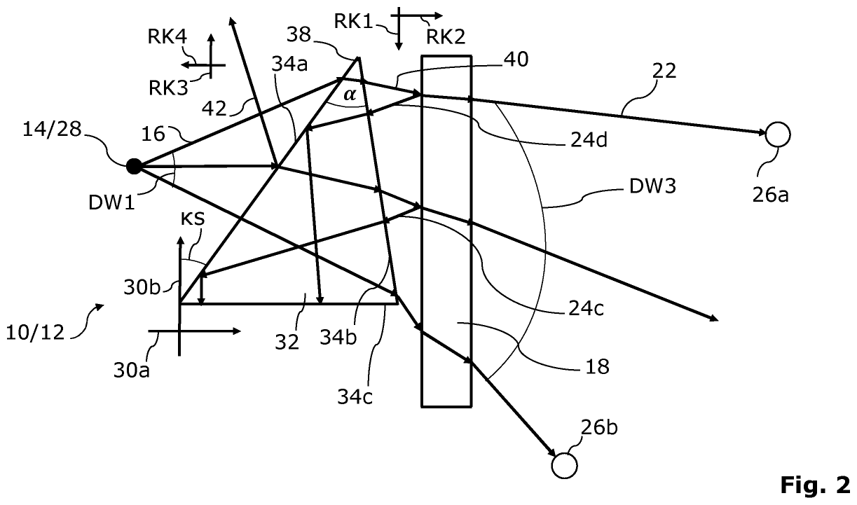

In the following text, the structure of the sensor system 10 is described on the basis of three sensor axes. The first sensor axis 30a extends in a direction from the detector 28 to the cover 18, with the first sensor axis 30a being orthogonal to the cover 18. The second sensor axis 30b (cf. FIG. 2, represented as a dot in FIG. 1) runs orthogonally to the first sensor axis 30a. A third sensor axis 30c runs in a direction from the detector 28 to the transmitter 14, with the third sensor axis 30c being orthogonal to the second sensor axis 30b and orthogonal to the first sensor axis 30a.

The transmitter 14 emits beams 16 in a first beam plane, which is defined by the first sensor axis 30a and second sensor axis 30b, at a first divergence angle DW1, see FIG. 2. Accordingly, the transmitter 14 emits beams 16 in a second beam plane, which is defined by the first sensor axis 30a and third sensor axis 30c (and is therefore orthogonal to the first beam plane), at a second divergence angle DW2, see FIG. 1. Typically, the second divergence angle DW2 has an angular size of around 45°. In FIG. 1, the second divergence angle DW2 is represented with a larger angular size for better representation of the beam patterns.

A prism 32 is arranged parallel to the third sensor axis 30c in the direction of the first sensor axis 30a between the detector 28 and the transmitter 14 on the one hand and the cover 18 on the other. A first flank 34a of the prism 32 faces the detector 28 and the transmitter 14. A second flank 34b of the prism 32 opposite the first flank 34a in the direction of the first sensor axis 30a faces the cover 18.

The first flank 34a of the prism 32 in particular has a smaller distance to the detector 28 and the transmitter 14 than the second flank 34b of the prism 32, whereas the second flank 34b of the prism 32 is arranged closer to the cover 18 than the first flank 34a of the prism 32. The prism 32 is configured in such manner (cf. FIG. 2) that the interference beams 24a, 24b are deflected past the detector 28. The interference beams 24a, 24b in particular experience a total reflection on the first flank 34a of the prism 32 such that the interference beams 24a, 24b no longer propagate to the detector 28. FIG. 1 also represents a prism edge 38 (cf. FIG. 2), which is arranged between the prism flanks 34a, 34b in the top view and runs parallel to the prism flanks 34a, 34b.

FIG. 2 shows a sectional view of the sensor system 10 along the first and second sensor axes 30a, 30b. The prism 32 has a shape in the form of a triangle with the first prism flank 34a facing the transmitter 14 and the detector 28, the second prism flank 34b facing the cover 18, and a third prism flank 34c formed adjoining the first and second prism flanks 30a, 30b.

The first prism flank 34a is inclined at a tilt angle κs in relation to the second sensor axis 30b. A prism angle α is formed between the first prism flank 34a and the second prism flank 34b. The third prism flank 34c is preferably aligned in such manner that a centre line (not shown) of the profile of the third prism flank 34c extends parallel to the first sensor axis 30a. The third prism flank 34c lies opposite the prism edge 38, at which the prism angle α is formed.

The transmitter 14 emits beams 16 in the first beam plane, which is defined by the first sensor axis 30a and second sensor axis 30b, at the first divergence angle DW1. In the embodiment shown, the tilt angle κS=37° and the prism angle α=45°. At these angular sizes of the tilt angle κs and the prism angle α, the beams 16 emitted by the transmitter 14 are refracted by the prism 32 in such manner that, after emerging from the prism 32, the propagation direction of beams 40 transmitted through the prism 32 has a first directional component RK1 in a direction from the prism edge 38 to the third prism flank 34c parallel or antiparallel to the second sensor axis 30b. In the alignment of the second sensor axis 30b shown in FIG. 2, the first directional component RK1 is aligned in particular antiparallel to the second sensor axis 30b. A second directional component RK2 of the propagation direction is aligned parallel or antiparallel to the first sensor axis 30a. In the alignment of the first sensor axis 30a shown in FIG. 2, the second directional component RK2 is aligned in particular parallel to the first sensor axis 30a. The prism 32 thus causes the solid angle illuminated by the useful beams 22 to swivel in the direction of the first directional component RK1 compared to the case where the prism 32 shown is not used in the optical sensor 12.

As a result, a second reflector 26b can be irradiated simultaneously with the first reflector 26a by the useful beams 22, which is offset with respect to the first reflector 26a in the direction of the first directional component RK1. The second reflector 26b is in particular a finger of a person approaching the sensor 12, with a fingerprint sensor (not shown) being intended to be activated by a signal from the optical sensor 12 in relation to the approaching finger.

The useful beams 22 emerge from the cover 18 on the side of the cover 18 opposite the prism in order to irradiate the reflectors 26a, 26b. The prism angle α and the tilt angle κs are designed in such manner that the useful beams 22, after emerging from the cover 18, have a third divergence angle DW3 at the surface of the cover 18 in the first beam plane, which divergence angle corresponds to the first divergence angle DW1. This prevents the electromagnetic beams from causing damage in the environment of the optical sensor 12 due to excessive radiant power. It also prevents the radiant power of the sensor 12 from being greatly reduced by the prism 32. The useful beams 22 are reflected by the reflectors 26a, 26b in the direction of the optical sensor 12 (cf. FIG. 1) in order to be detected there by the detector 28 for determining the distance or position of the reflectors 26a, 26b.

Particularly preferably, detecting an approach of the reflector 26a is used to terminate a sleep or power saving mode of the sensor 12 and/or detecting an approach of the reflector 26b is used to increase the significance of data obtained from a fingerprint sensor or another sensor (not shown).

The interference beams 24c, 24d shown in FIG. 2 are generated by reflection of the beams 16, which are emitted by the transmitter 14, on the cover 18. In the embodiment shown, in particular with the aforementioned selection of the tilt angle κs and the prism angle α, the interference beams 24c, 24d experience total reflection on the first prism flank 34a such that they do not radiate onto the transmitter 14. Accordingly, the interference beams 24c, 24d also do not propagate to the detector 28 (cf. FIG. 1).

Beams 16 emitted by the transmitter 14 are partially reflected on the first prism flank 34a. The propagation direction of the further interference beams 42 reflected on the first prism flank 34a have a third directional component RK3, which is oriented parallel or antiparallel to the second sensor axis 30b in the direction from the third prism flank 34c to the prism edge 38. In the alignment of the second sensor axis 30b shown in FIG. 2, the third directional component RK3 is aligned in particular parallel to the second sensor axis 30b. In addition, the propagation direction of the beams 42 reflected on the first prism flank 34a has a fourth directional component RK4, which is oriented parallel or anti-parallel to the first sensor axis 30a in the direction from the cover 18 to the transmitter 14. In the alignment of the first sensor axis 30a shown in FIG. 2, the fourth directional component RK4 is aligned in particular antiparallel to the first sensor axis 30a. The third directional component RK3 is sufficiently large at the tilt angle κs and the prism angle α in the embodiment of the prism 32 shown that distances between the prism 32 and the transmitter 14 can be selected at which the beams 42 reflected on the first prism flank 34a also propagate past the transmitter 14 (and past the detector 28).

The prism 32 thus prevents the beams 16 emitted by the transmitter 14 from being reflected back both into the transmitter 14 and the detector 28. There is no crosstalk from the detector 28. Noise signals or interference signals generated by the interference beams 24c, 24d, which impair the accuracy of the distance measurement of the reflectors 26a, 26b or prevent the distance measurement, do not occur.

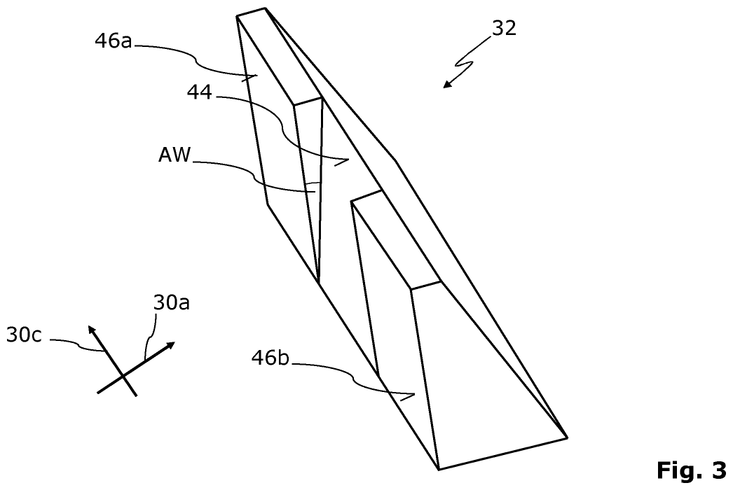

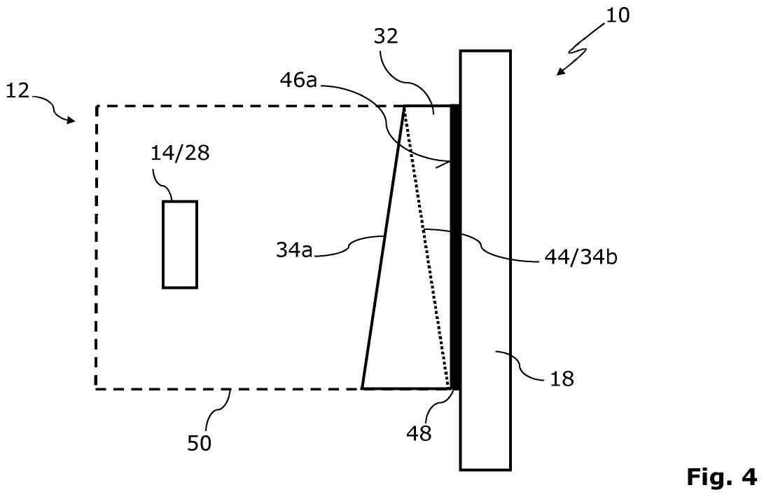

FIG. 3 shows an isometric view of the prism 32, with the prism 32 having an optical surface 44 for transmitting electromagnetic beams 16 (cf. FIG. 1). Two adhesive surfaces 46a, 46b, to which, for example, adhesive pads (not shown) can be attached, adjoin the optical surface 44 on both sides in order to thereby fix the prism 32 and thus the entire sensor 12 (cf. FIG. 4). The optical surface 44 and the adhesive surfaces 46a, 46b are arranged next to one another in a direction parallel to the third sensor axis 30c and thus perpendicular to the first sensor axis 30a. The adhesive surfaces 46a, 46b are aligned at an acute alignment angle AW to the optical surface 44 such that the adhesive surfaces 46a, 46b protrude from the optical surface 44. The plane in which the optical surface 44 runs and the plane in which the adhesive surfaces 46a, 46b run in particular include the acute alignment angle AW. The optical surface 44 is preferably formed as the first prism flank 34a or the second prism flank 34b (cf. FIG. 2).

FIG. 4 schematically shows a side view of a sensor system 10 with the sensor 12, with the prism 32 with the adhesive surfaces 46a, 46b (cf. FIG. 3) being adhered to the cover 18 by an adhesive connection 48, in particular adhesive pads. FIG. 4 shows the adhesive surface 46a. The optical surface 44 between the adhesive surfaces 46a, 46b is represented as a dotted line in FIG. 4. In the embodiment of the sensor system shown in FIG. 4, the optical surface 44 is formed as the second prism flank 34b, which is opposite the first prism flank 34a. In addition to the transmitter 14 and detector 28, the sensor 12 also comprises a housing 50, which is shown dashed in FIG. 4.

Taking all the figures of the drawing together, the disclosure relates to an optical sensor 12 with a prism 32 positioned between a detector 28 of the sensor 12 and a cover 18. A surface normal of a first prism flank 34a of the prism 32 directed outwardly starting from the prism 32 points in the direction of the detector 28. A surface normal of a second prism flank 34b of the prism 32 directed outwardly starting from the prism 32 points in the direction of the cover 18. Limbs of a prism angle α extend along the first and second prism flank 34a, 34b. A first sensor axis 30a runs in a direction through the detector 28 and the cover 18, with the first sensor axis 30a being aligned orthogonally to the cover 18. A second sensor axis 30b is orthogonal to the first sensor axis 30a, with the cover 18 extending in particular with its longest extension along the second sensor axis (30b). The first prism flank 34a is oriented obliquely towards the second sensor axis 30b at a tilt angle κs. The cover 18 transmits at least a part of electromagnetic beams 16 emitted by a transmitter 14 of the sensor 12. The detector 28 is designed to detect the beams 16 emitted by the transmitter 14. The tilt angle κS and the prism angle α have angular sizes such that interference beams 24a-24d propagate at least partially past the detector 28, with the interference beams 24a-24d being generated by reflection of beams 16, which are emitted from the transmitter 14, on the cover 18.

1. An optical sensor for low-interference travel time measurement of reflected electromagnetic beams, the optical sensor comprising:
a transmitter for transmitting the electromagnetic beams through a cover, wherein the cover is permeable to at least a part of the beams emitted by the transmitter;
a detector for detecting the electromagnetic beams;
a first sensor axis that runs in a direction from the detector to the cover, wherein the first sensor axis is orthogonal to the cover;
a second sensor axis that is orthogonal to the first sensor axis;
wherein
a prism is arranged between the detector and the cover, wherein the prism has a first prism flank facing the detector, wherein the first prism flank is inclined at a tilt angle (κs) in relation to the second sensor axis,
wherein the prism has a second prism flank which adjoins the first prism flank and faces the cover, wherein a prism angle (α) is formed between the first prism flank and the second prism flank,
wherein a third prism flank adjoins the first prism flank and the second prism flank,
wherein the prism angle (α) and the tilt angle (κs) are designed in such manner that interference beams are at least partially deflected past the detector by means of the prism, wherein the interference beams are generated by electromagnetic beams being emitted by the transmitter in the direction of the cover and being reflected on the prism and/or the cover.

2. The sensor according to claim 1, wherein the prism is arranged in the direction of the first sensor axis between the detector, the transmitter and the cover, wherein the first prism flank faces the detector and the transmitter.

3. The sensor according to claim 1, wherein the third prism flank has a predetermined roughness to reduce reflections of electromagnetic radiation on the third prism flank.

4. The sensor according to claim 1, wherein the transmitter is configured to emit electromagnetic beams in a first beam plane, which is defined by the first sensor axis and the second sensor axis, at a first divergence angle (DW1) with 40°≤DW1≤50%, wherein the first sensor axis runs through the apex of the first divergence angle (DW1) and between the limbs of the first divergence angle (DW1), wherein the first sensor axis forms an angle bisector of the first divergence angle (DW1).

5. The sensor according to claim 4, wherein the transmitter is configured to emit electromagnetic radiation in a second beam plane, which is orthogonal to the first beam plane, at a second divergence angle (DW2) with 40°≤DW2≤50°, wherein the first sensor axis runs through the second beam plane.

6. The sensor according to claim 1, wherein the prism is configured to refract the beams emitted by the transmitter in an irradiation direction which has a first directional component (RK1) parallel to the second sensor axis, wherein the first directional component (RK1) is directed from a prism edge, which is opposite the third prism flank, to the third prism flank, wherein a second directional component (RK2) of the irradiation direction is directed parallel to the first sensor axis.

7. The sensor according to claim 1, wherein the prism is configured to refract the beams emitted by the transmitter in such manner that, after emerging from the cover in the first beam plane, useful beams branched off from the emitted beams have a third divergence angle DW3, the angular size of which corresponds to the angular size of the first divergence angle (DW1).

8. The sensor according to claim 1, wherein the following applies for the tilt angle (κs): 30°≤κs≤40°, and/or for the prism angle (α): 40°≤α≤50°.

9. The sensor according to claim 1, wherein the transmitter and the detector are arranged next to one another in a direction parallel to a third sensor axis, wherein the third sensor axis runs orthogonally to the first sensor axis and the second sensor axis, wherein the transmitter is aligned to emit electromagnetic beams with a beam direction which has a directional component perpendicular to the third sensor axis, and the detector is aligned to detect electromagnetic beams with a beam direction which has a directional component perpendicular to the third sensor axis.

10. The sensor according to claim 1, wherein the prism comprises PMMA and/or a polycarbonate.

11. The sensor according to claim 1, wherein the sensor, has at least one optical surface and at least one adhesive surface, wherein the optical surface is designed to transmit electromagnetic beams; optionally wherein the optical surface adjoins at least one, preferably at least two, adhesive surface(s), wherein the optical surface and the adhesive surface(s) are arranged next to one another in a direction perpendicular to the first sensor axis.

12. The sensor according to claim 11, wherein the optical surface is formed as the first prism flank or the second prism flank.

13. A sensor system, having a sensor according to claim 1 and a cover, wherein a side surface of the cover, which is configured to be irradiated by the electromagnetic beams emitted by the transmitter, extends parallel to the second sensor axis.

14. The sensor system according to claim 13, wherein the sensor is fastened to the cover by way of an adhesive connection.

15. The sensor system according to claim 13, wherein the sensor system has a further sensor and/or a facial recognition camera.

16. An electronic interaction device for inputting and/or outputting signals, having a sensor system according to claim 13, wherein the electronic interaction device is designed as a car entertainment system, an access control device, a time recording terminal and/or an attendance recording system.

17. A use of a prism for operating a sensor according to claim 1, wherein interference beams are at least partially deflected past the detector by means of the prism, wherein the interference beams are generated by electromagnetic beams being emitted by the transmitter in the direction of the cover and being reflected on the prism and/or the cover.
